(19) United States
(12) Patent Application Publication
(10) Pub. No.: US 2022/0412527 A1
(43) Pub. Date: Dec. 29, 2022

(54) VEHICULAR LIGHT-GUIDING BODY AND VEHICULAR LAMP UNIT

(71) Applicant: Ichikoh Industries, Ltd., Isehara-shi (JP)

(72) Inventor: Kei ONOMA, Isehara-shi (JP)

(73) Assignee: Ichikoh Industries, Ltd., Isehara-shi (JP)

(21) Appl. No.: 17/780,928

(22) PCT Filed: Nov. 25, 2020
(86) PCT No.: PCT/JP2020/043891

§ 371 Date: May 27, 2022

(30) Foreign Application Priority Data
Nov. 27, 2019 (JP) 2019-214561

(51) Int. Cl. F21S 41/24; F21S 41/147

(52) U.S. Cl. CPC F21S 41/24; F21S 41/147

(57) ABSTRACT

A vehicular light-guiding body includes: an incidence surface on which light from a light source is incident; a first reflection surface; a second reflection surface; a connecting surface that has a transmission surface which transmits a portion of the light reflected by the second reflection surface from a lower side in an up-down direction on the onboard state to a guiding body outer part, and directs the light forward in the front-rear direction; a re-incidence surface that is disposed on a front side in the front-rear direction with respect to the transmission surface and on a lower side in the up-down direction with respect to the light blocking part, and allows the light transmitted from the transmission surface to the guiding body outer part to be re-incident; and an emission surface that emits the light internally reflected by the second reflection surface, and the light incident from the re-incidence surface.

### TECHNICAL FIELD

The present invention relates to a vehicular light-guiding body and a vehicular lamp unit.

### BACKGROUND ART

There is known a configuration in which respective functions corresponding to a reflector, a shade, a projection lens, and the like are integrated into one vehicular light-guiding body (see, for example, PTL 1). That is, such a vehicular light-guiding body includes an incidence surface on which light from a light source is incident, an internal reflection surface (corresponding to a reflector) that internally reflects the incident light, a light blocking part (corresponding to a shade) that blocks a portion of the internally reflected light, and an emission surface (corresponding to a projection lens) that emits the light internally reflected to pass through the light blocking part, and projects a diffusion pattern PF toward a front of a vehicle.

### CITATION LIST

### Patent Literature

PTL 1: U.S. Pat. No. 6,130,602

### SUMMARY OF THE INVENTION

### Problems to be Solved by the Invention

In the vehicular light-guiding body described in PTL 1, there is a need to improve the efficiency of light utilization such that light incident from the incidence surface can be reflected internally to reach the emission surface with as little loss as possible.

The present invention has been made in view of the above, and an object of the present invention is to provide a vehicular light-guiding body and a vehicular lamp unit capable of improving light utilization efficiency

### Means for Solving the Problem

A vehicular light-guiding body according to the present invention includes: an incidence surface on which light from a light source is incident; a first reflection surface that internally reflects the light incident from the incidence surface and converts the light into substantially parallel light; a second reflection surface that internally reflects, forward in a front-rear direction in an onboard state, the substantially parallel light from the first reflection surface; a light blocking part that blocks a portion of the light reflected by the second reflection surface; a connecting surface that connects the second reflection surface and the light blocking part, and has a transmission surface which transmits a portion of the light reflected by the second reflection surface from a lower side in an up-down direction on the onboard state to a guiding body outer part, and directs the light forward in the front-rear direction; a re-incidence surface that is disposed on a front side in the front-rear direction with respect to the transmission surface and on a lower side in the up-down direction with respect to the light blocking part, and allows the light transmitted from the transmission surface to the guiding body outer part to be re-incident; and an emission surface that emits the light internally reflected by the second reflection surface, and the light incident from the re-incidence surface.

In the above vehicular light-guiding body, the second reflection surface may have a condensing pattern forming surface that internally reflects the substantially parallel light such that the substantially parallel light is condensed forward in the front-rear direction, and the transmission surface may be disposed within a region where reflected light internally reflected by the condensing pattern forming surface passes, as viewed from the up-down direction.

In the above vehicular light-guiding body, the connecting surface may have a recessed part disposed on the front side in the front-rear direction with respect to the transmission surface, and recessed toward a guiding body inner part, and an inclined surface that is a portion of the recessed part, that is provided between the transmission surface and the light blocking part in the connecting surface so as to be inclined downward in the up-down direction toward the front side in the front-rear direction, and that internally reflects, forward in the front-rear direction, a portion of the light reflected by the second reflection surface may be further provided.

In the above vehicular light-guiding body, the inclined surface may have a first external light blocking part that is disposed so as to protrude on the guiding body outer part, and blocks a portion of light transmitted from the transmission surface to the guiding body outer part.

In the above vehicular light-guiding body, a second external light blocking part that is disposed on the front side in the front-rear direction with respect to the transmission surface in the connecting surface so as to protrude on the guiding body outer part, and blocks a portion of light transmitted from the transmission surface to the guiding body outer part may be further provided.

In the above vehicular light-guiding body, the transmission surfaces are disposed on both sides with a space at a central part in a left-right direction in the onboard state.

In the above vehicular light-guiding body, the emission surface may project a diffusion pattern toward a front of a vehicle.

A vehicular lamp unit according to the present invention includes: a light source; and a plurality of the above vehicular light-guiding bodies, each of the vehicular light-guiding bodies being configured to guide and emit light from the light source.

### Effect of the Invention

According to the present invention, it is possible to improve light utilization efficiency.

### BRIEF DESCRIPTION OF THE DRAWINGS

FIG. 1 is a plan view illustrating an example of a vehicle vehicular lamp according to this embodiment.

FIG. 2 is a bottom view illustrating an example of the vehicular lamp according to this embodiment.

FIG. 3 is a diagram illustrating a configuration taken along the A-A section in FIG. 1.

FIG. 4 is a perspective view illustrating an example of a vehicular light-guiding body viewed from a lower side.

FIG. 5 is an enlarged view illustrating a portion of FIG. 3.

FIG. 6 is a diagram illustrating an example of a diffusion pattern projected on a virtual screen in front of a vehicle.

FIG. 7 is a diagram illustrating an example of a vehicular lamp unit according to this embodiment.

### MODE FOR CARRYING OUT THE INVENTION

Hereinafter, an embodiment of a vehicular light-guiding body and a vehicular lamp unit according to the present invention will be described with reference to the drawings. This invention is not limited to the embodiment. In addition, components in the following embodiment include those that are substitutable and easy to be replaced by those skilled in the art, or those that are substantially identical. In the following description, the front-rear, up-down, and right-left directions indicate directions in an on-board state in which a vehicular headlight is mounted on a vehicle, and also indicate the directions when viewed in the direction of travel of the vehicle from a driver's seat. In this embodiment, the up-down direction is parallel to the vertical direction and the left-right direction is the horizontal direction.

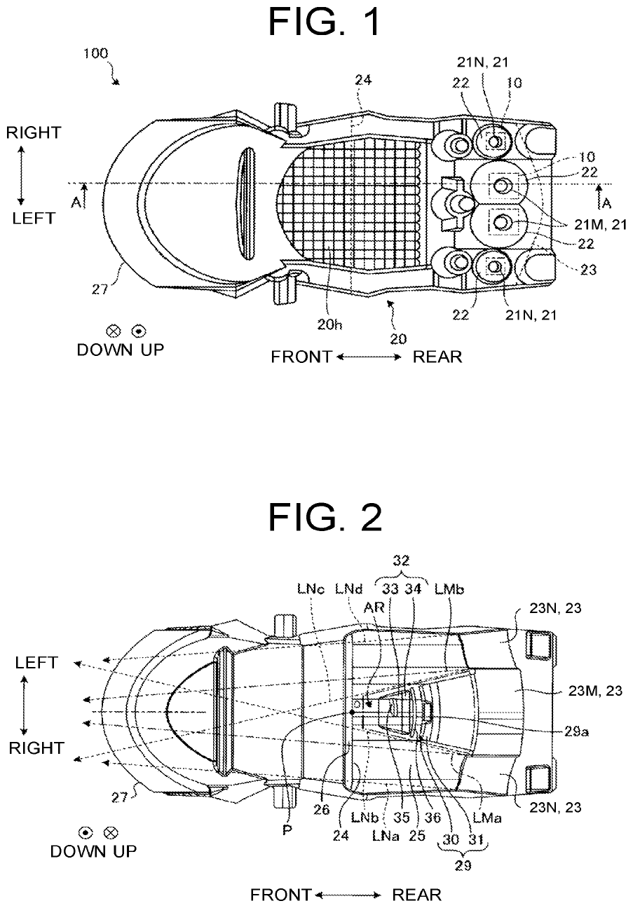

FIG. 1 is a plan view illustrating an example of a vehicular lamp 100 according to this embodiment. FIG. 2 is a bottom view illustrating an example of the vehicular lamp 100 according to this embodiment. FIG. 3 is a diagram illustrating a configuration taken along the A-A section in FIG. 1.

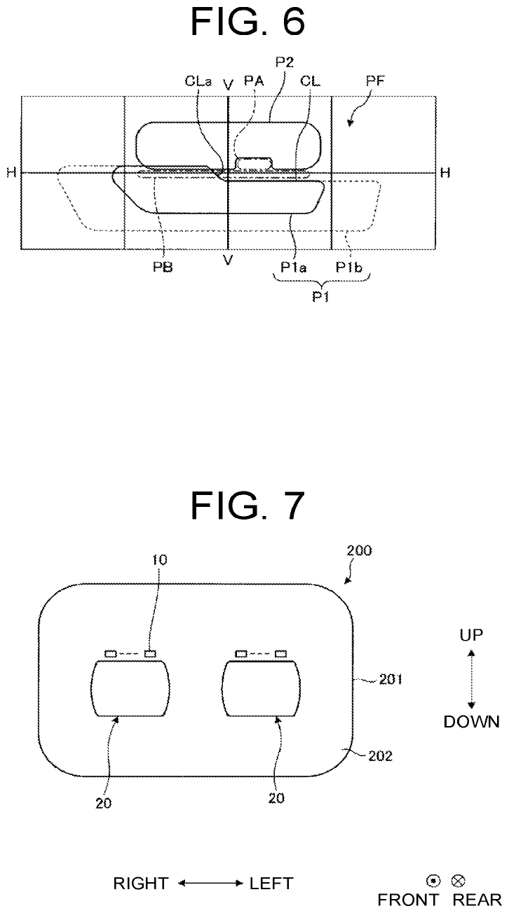

The vehicular lamp 100 can project a diffusion pattern PF (see FIG. 6) described below toward a front of a vehicle. In this embodiment, the diffusion pattern PF includes, for example, a low-beam pattern P1 and an overhead pattern P2. The vehicular lamp 100 includes light sources 10, and a vehicular light-guiding body 20. The vehicular lamp 100 may further include another unit having a light source, a reflector, a shade, a projection lens, and the like. In this embodiment, the following description will take as an example a configuration of the vehicular lamp 100 mounted on a vehicle that travels on a left-hand traffic.

[Light Source]

For each light source 10, in this embodiment, a semiconductor type light source such as an LED and an OLED (organic EL), a laser light source and the like are used, for example. Light emitting surfaces 11 are disposed so as to face incidence surfaces 21 of the vehicular light-guiding body 20 described later. The light emitting surfaces 11 are disposed in a state of being directed toward the vehicular light-guiding body 20. In this embodiment, a plurality of the light sources 10, for example, four are disposed in the left-right direction. The number of the light sources 10 is not limited to four, but may be three or less, or five or more.

[Vehicular Light-guiding Body]

The vehicular light-guiding body 20 guides light from the light sources 10 and emits the light toward the front of the vehicle in an onboard state. The vehicular light-guiding body 20 according to this embodiment has a configuration in which respective functions corresponding to a reflector, a shade, a projection lens and the like in a conventional projector-type vehicular headlight, for example, are integrated. As illustrated in FIG. 1 to FIG. 3, the vehicular light-guiding body 20 includes the incidence surfaces 21, first reflection surfaces 22, second reflection surfaces 23, a light blocking part 24, a connecting surface 25, a re-incidence surface 26, and an emission surface 27.

[Incidence Surface]

A plurality of the incidence surfaces 21 are provided, for example, one for each light source 10. Each incidence surface 21 may be provided at such a position as not to correspond to the light source 10 in a one-to-one manner. For example, a plurality of the incidence surfaces 21 may be provided for the single light source 10. The plurality of incidence surfaces 21 are disposed side by side in the left-right direction in the onboard state. The incidence surfaces 21 are each formed in the shape of a cone, for example. In this embodiment, for example, the four incidence surfaces 21 are arranged. The diameter of each of the incidence surfaces 21 disposed on the outer side in the left-right direction is smaller than the diameter of each of the incidence surfaces 21 disposed on the central side in the left-right direction. In this embodiment, the diameter of each of the two incidence surfaces 21 disposed on the outer side in the left-right direction is smaller than the diameter of each of the two incidence surfaces 21 on the central side in the left-right direction. Hereinafter, the two incidence surfaces 21 on the central side in the left-right direction are each written as a central incidence surface 21M, the two incidence surfaces on the outer side in the left-right direction are each written as an outer incidence surface 21N, and both may be distinguished from each other.

Each incidence surface 21 has a first surface 21a and a second surface 21b, as illustrated in FIG. 3. Light from each light source 10 is incident on the first surface 21a and the second surface 21b. The first surface 21a faces the light emitting surface 11. The first surface 21a is a flat surface or a convex surface protruding toward the light source 10. The second surface 21b is disposed on the lateral side of the light source 10 and is disposed in the shape of a cylindrical surface so as to surround the light emitting surface 11 and the first surface 21a of the light source 10.

[First Reflection Surface]

Each first reflection surface 22 internally reflects light incident from the incidence surface 21 and converts the reflected light into substantially parallel light. The first reflection surface 22 is disposed so as to surround the second surface 21b of the incidence surface 21, and reflects light incident from the second surface 21b toward the second reflection surface 23. In this embodiment, the first reflection surfaces 22 are provided so as to correspond to the incidence surfaces 21. The two first reflection surfaces 22 disposed on the central side in the left-right direction are disposed in a state of being partially overlapped on each other.

[Second Reflection Surface]

Each second reflection surface 23 has a shape based on a paraboloid of revolution. The second reflection surfaces 23 has a focal point P that coincides with or substantially coincides with a focal point of the paraboloid of revolution. The focal point P is disposed at a position in the vicinity of the focal point of the emission surface 27, which will be described below. The second reflection surface 23 reflects substantially parallel light from the first reflection surface 22 toward the focal point P, that is, toward the front of the vehicle. The second reflection surface 23 has an axis parallel to an optical axis of the substantially parallel light reflected by the first reflection surface 22, and internally reflects the substantially parallel light toward the focal point P of the paraboloid of revolution.

A plurality of the second reflection surfaces 23 are disposed side by side in the left-right direction in the onboard state, as illustrated in FIG. 2. The plurality of second reflection surfaces 23 include a condensing pattern forming surface 23M and diffusion pattern forming surfaces 23N. The condensing pattern forming surface 23M internally reflects the substantially parallel light such that the substantially parallel light passes through the focal point P and the vicinity of the focal point P. The condensing pattern forming surface 23M is disposed at the center in the left-right direction. The condensing pattern forming surface 23M is disposed so as to correspond to the two central incidence surfaces 21M. The condensing pattern forming surface 23M reflects substantially parallel light that is incident on each of the two central incidence surfaces 21M, and is reflected by each of the first reflection surfaces 22. In a case where the vehicular light-guiding body 20 is viewed from the lower side, as illustrated in FIG. 2, the condensing pattern forming surface 23M can reflect the substantially parallel light to a region between a virtual straight line LMa and a virtual straight line LMb in the left-right direction, for example.

Each diffusion pattern forming surface 23N internally reflects substantially parallel light such that the substantially parallel light passes through a position shifted to the outer side in the horizontal direction in the onboard state with respect to the focal point P including the focal point P. Therefore, the diffusion pattern forming surfaces 23N each have a shape in which, for example, an edge of the condensing pattern forming surface 23M side in the left-right direction is deformed to the focal point P side (forward) with respect to the shape based on the paraboloid of revolution. Among the plurality of second reflection surfaces 23, the second reflection surfaces 23 disposed on the outer side in the left-right direction with respect to the condensing pattern forming surface 23M is the diffusion pattern forming surfaces 23N. The diffusion pattern forming surfaces 23N are disposed so as to correspond to the respective outer incidence surfaces 21N. The diffusion pattern forming surfaces 23N each reflect the substantially parallel light incident on the outer incidence surface 21N and reflected by the first reflection surface 22. In a case where the vehicular light-guiding body 20 is viewed from the lower side, as illustrated in FIG. 2, the diffusion pattern forming surface 23N reflects the substantially parallel light to each of an region between a virtual straight line LNa and a virtual straight line LNb in the left-right direction and an region between a virtual straight line LNc and a virtual straight line LNd in the left-right direction, for example.

In a case of being viewed from the lower side as illustrated in FIG. 2, reflected light internally reflected by the condensing pattern forming surface 23M mainly passes through the region between the virtual straight line LMa and the virtual straight line LMb in the left-right direction. In addition, reflected light internally reflected on the diffusion pattern forming surface 23N mainly passes through each of the region between the virtual straight line LNa and the virtual straight line LNb and the region between the virtual straight line LNc and the virtual straight line LNd, and partial light passes through the region (rear side in the front-rear direction) between the virtual straight line LNb and the virtual straight line LNc. In this embodiment, a portion of region, through which the reflected light internally reflected on the condensing pattern forming surface 23M mainly pass, and a portion of the reflected light internally reflected on each of the diffusion pattern forming surfaces 23N passes, is set as an region AR. The region AR has a tapered shape from the second reflection surface 23 side to the front side. In addition, the region AR has a shape along the virtual straight line LNb and the virtual straight line LNc indicating a range where the reflected light internally reflected on each of the diffusion pattern forming surfaces 23N mainly passes.

[Light Blocking Part]

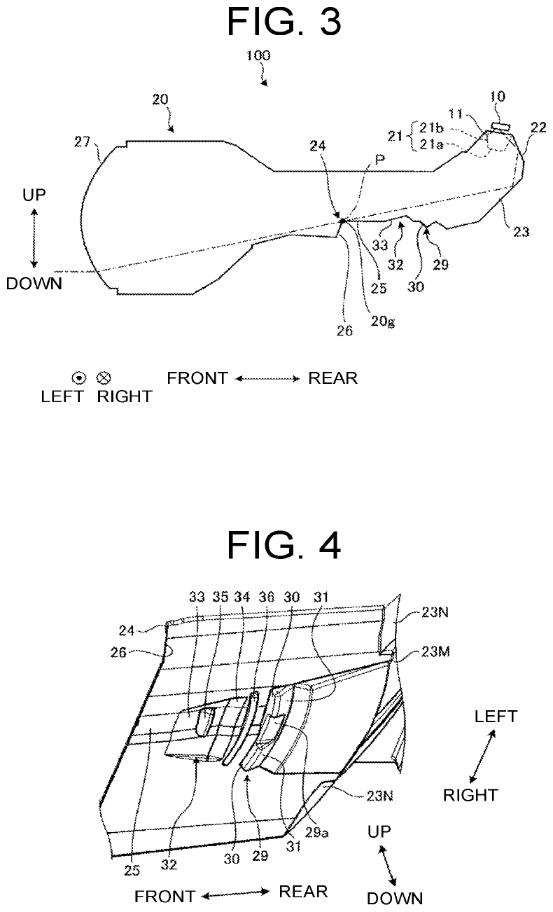

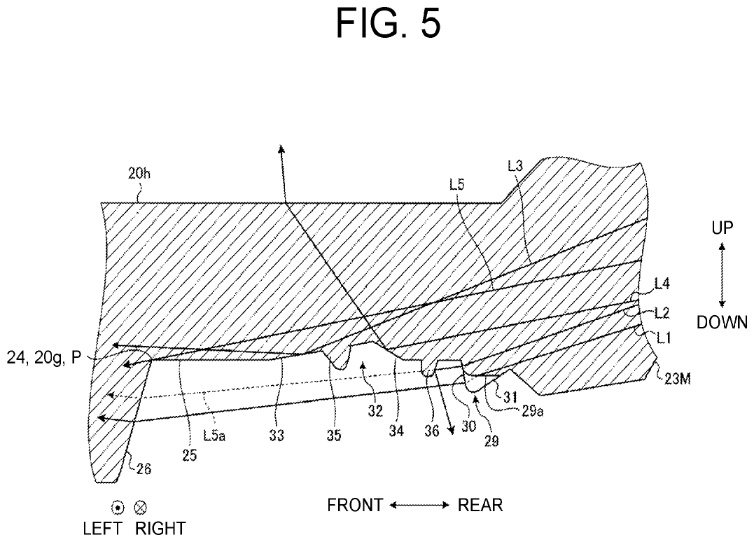

The light blocking part 24 blocks a portion of light internally reflected by the second reflection surfaces 23. FIG. 4 is a perspective view illustrating an example of the vehicular light-guiding body 20 viewed from a lower side. FIG. 5 is an enlarged view illustrating a portion of FIG. 3.

As illustrated in FIG. 3 to FIG. 5, for example, the light blocking part 24 is provided in a corner 20g formed by the connecting surface 25 and the re-incidence surface 26 described below. The corner 20g has a recessed shape when the vehicular light-guiding body 20 is viewed from the outer side (lower side). The corner 20g linearly extends in the left-right direction. The light blocking part 24 forms a cutoff line CL (see FIG. 6) of the low-beam pattern P1 in the diffusion pattern PF described later, at the corner 20g. The cutoff line CL includes a horizontal cutoff line and an oblique cutoff line. The corner 20g has a horizontal portion (not illustrated) for forming the horizontal cutoff line and an inclined portion (not illustrated) for forming the oblique cutoff line

The light blocking part 24 is provided in a region including the corner 20g. The light blocking part 24 may block light, for example, by refracting or internally reflecting, in a direction different from the direction of the emission surface 27, light which arrives at the light blocking part 24, or may block light by disposing a light absorbing layer on a portion, which corresponds to the light blocking part 24, in the connecting surface 25 including the corner 20g, and absorbing light by the light absorbing layer.

The light internally reflected or refracted by the light blocking part 24 is emitted to the outside of the vehicular light-guiding body 20 and absorbed by an inner housing or the like disposed outside the vehicular light-guiding body 20.

[Connecting Surface]

The connecting surface 25 connects the second reflection surfaces 23 and the light blocking part 24. The connecting surface 25 is located on the lower side of the vehicular light-guiding body 20, and is disposed along a horizontal plane. The connecting surface 25 is provided with a protruding part 29.

The protruding part 29 is disposed in front of the condensing pattern forming surface 23M. The protruding part 29 has a configuration of protruding in a V-shape from the connecting surface 25 toward the lower side in the cross-sectional view. The protruding part 29 has transmission surfaces 30 disposed on the front side in the front-rear direction, and transmission-side reflection surfaces 31 disposed on the rear side. As illustrated in FIG. 2, the protruding part 29 has a tapered shape toward the front side. With the above, the transmission surfaces 30 and the transmission-side reflection surfaces 31 each has a tapered shape toward the front side.

The transmission surfaces 30 has, for example, a planar shape, and has an inclined shape from the rear side toward the front side. Each transmission surface 30 transmits light from the second reflection surface 23 to an outer part of the vehicular light-guiding body 20, and refracts the light forward (see FIG. 5). The light transmitted from each transmission surface 30 to the guiding body outer part to travel forward is incident on the re-incidence surface 26 described below, and forms the overhead pattern P2 (see FIG. 6) described below emitted from the emission surface 27 toward the front of the vehicle.

As illustrated in FIG. 2, the transmission surfaces 30 are disposed within a region where reflected light internally reflected on the condensing pattern forming surface 23M passes, as viewed from the lower side in the up-down direction, for example. In this embodiment, as viewed from the lower side, the transmission surfaces 30 are disposed within the region AR that is tapered forward from both ends in the left-right direction of the condensing pattern forming surface 23M to the focal point P.

The transmission-side reflection surfaces 31 each have a shape inclined upward from the front side to the rear side. Each transmission-side reflection surface 31 reflects, toward the transmission surface 30 on the front side, light which enters a protruding portion from the rear side or the upper side.

The protruding part 29 has a planar cutout surface 29a at the center in the left-right direction. The cutout surface 29a is provided such that a central part in the left-right direction of the protruding part 29 is cut out along the horizontal plane. The cutout surface 29a is provided in the protruding part 29, and therefore the above transmission surfaces 30 and transmission-side reflection surfaces 31 are disposed on the both sides with a space at the central part in the left-right direction. Inside the vehicular light-guiding body 20, light incident on the cutout surface 29a is internally reflected on the cutout surface 29a. The cutout surface 29a is provided, so that it is possible to control the luminous intensity of the overhead pattern P2 (see FIG. 6). In this embodiment, with the cutout surface 29a, the transmission surfaces 30 are disposed on the left and right at an interval, and therefore it is possible to obtain sufficiently diffusion to the left and right of the overhead pattern P2, and it is possible to suppress excessive rise of the luminous intensity of the central part. The cutout surface 29a may not be provided. In addition to the configuration in which the central part of a transmission surface 30 may has the cutout surface 29a, for example, the areas of the transmission surface 30 may be reduced, or a portion of the transmission surface 30 may be processed.

The connecting surface 25 is provided with a recessed part 32. The recessed part 32 is disposed between the transmission surfaces 30 and the light blocking part 24 in the front-rear direction. The recessed part 32 has a shape recessed in a V-shape from the connecting surface 25 toward the inner side of the vehicular light-guiding body 20 in the cross-sectional view. The recessed part 32 has an inclined surface 33 and an upper reflection surface 34. That is, the inclined surface 33 is a portion of the recessed part 32.

The inclined surface 33 has, for example, a planar shape, and is inclined downward in the up-down direction from the rear side to the front side in the front-rear direction. The inclined surface 33 internally reflects, toward the front side, a portion of light reflected on each second reflection surface 23. The light internally reflected on the inclined surface 33 passes through a position closer to the light blocking part 24, compared to light internally reflected on the connecting surface 25 that is not provided with the inclined surface 33. Accordingly, in a case where the light emits from the emission surface 27, the light is projected to a region closer to the cutoff line CL. Therefore, compared to the case where no inclined surface 33 is provided, visibility from a long distance is improved. The inclined surface 33 disposed in front of the transmission surfaces 30 is provided as a portion of the recessed part 32, so that it is possible to prevent blocking of light transmitted through the transmission surfaces 30 and traveling toward the guiding body outer part disposed on the front side, for example, compared to the case where the inclined surface 33 is provided as a portion of the protruding part that protrudes toward the lower side of the connecting surface 25. As illustrated in FIG. 2, the recessed part 32 has a tapered shape toward the front side. With the above, for example, the inclined surface 33 also has a tapered shape toward the front side.

The inclined surface 33 is provided with a first external light blocking part 35. The first external light blocking part 35 is configured such that a portion of the inclined surface 33 protrudes downward. The first external light blocking part 35 blocks a portion of light transmitted from each transmission surface 30 to the guiding body outer part to travel forward. Specifically, the first external light blocking part 35 blocks light projected to a portion of a region PA at a lower side on an opposite lane side in the overhead pattern P2 (see FIG. 6).

The upper reflection surface 34 has, for example, a planar shape, and is inclined downward in the up-down direction from the front side to the rear side in the front-rear direction, contrary to the inclined surface 33. The upper reflection surface 34 is disposed behind the inclined surface 33, and forms the V-shaped recessed part 32 to together with the inclined surface 33. The upper reflection surface 34 has a larger inclination angle to the connecting surface 25 than the inclined surface 33. The upper reflection surface 34 internally reflects a portion of light reflected on the second reflection surfaces 23 toward an upper surface 20h. The light reflected on the upper reflection surface 34 is partially emitted from the upper surface 20h to the outside of the vehicular light-guiding body 20, and partially reflected on the upper surface 20h to be diffused. The light reflected on the upper reflection surface 34 does not reach the emission surface 27, and is absorbed by an inner housing or the like disposed outside the vehicular light-guiding body 20. Therefore, generation of glare light is suppressed.

The connecting surface 25 is provided with a second external light blocking part 36. The second external light blocking part 36 is disposed between the transmission surfaces 30 and the recessed part 32. The second external light blocking part 36 is configured such that a portion of the connecting surface 25 protrudes downward. The second external light blocking part 36 is disposed with in the region AR through which substantially parallel light internally reflected on the condensing pattern forming surface 23M passes, as viewed from the up-down direction. The second external light blocking part 36 blocks a portion of light transmitted from the transmission surfaces 30 to the guiding body outer part to travel forward. Specifically, the second external light blocking part 36 blocks light projected to a region PB in the vicinity of the H-H line in the overhead pattern P2 (see FIG. 6).

The above first external light blocking part 35 and second external light blocking part 36 may block light by, for example, refracting or internally reflecting, in the direction opposite to the direction of the re-incidence surface 26, light which reaches the first external light blocking part 35 and the second external light blocking part 36, or light absorbing layers may be disposed on surfaces of the first external light blocking part 35 and the second external light blocking part 36 may block by absorbing light by the light absorbing layers. The light internally reflected or refracted by each of the first external light blocking part 35 and the second external light blocking part 36 is absorbed by the inner housing or the like disposed outside the vehicular light-guiding body 20.

[Re-Incidence Surface]

The re-incidence surface 26 is provided so as to be bent downward with respect to the connecting surface 25. The re-incidence surface 26 is formed so as to be inclined forward from an upper part to a lower part. The re-incidence surface 26 causes light transmitted from each of the transmission surfaces 30 to the outside to be re-incident. The light re-incident from the re-incidence surface 26 travels from the lower side of the light blocking part 24 toward the emission surface 27.

[Emission Surface]

The emission surface 27 emits the light internally reflected by each second reflection surface 23 to not to be blocked by the light blocking part 24, and the light incident from the re-incidence surface 26, and projects the diffusion pattern PF (see FIG. 6) toward the front of the vehicle. In this embodiment, the emission surface 27 has, for example, a curved surface, and has a focal point (not illustrated), and an optical axis. The emission surface 27 may be, for example, a planar shape, and other optical element that projects light emitted from the emission surface 27 toward the front of the vehicle may be disposed. The focal point of the emission surface 27 is disposed at a position in the vicinity of the focal point P of the second reflection surfaces 23. In this embodiment, the width in the left-right direction of the emission surface 27 is narrower than the width in the left-right direction of the second reflection surfaces 23. In this case, the dimensions of the emission surface 27 when viewed from the outside can be controlled.

A light diffusion part such as a prism part may be formed on the upper surface 20h of the vehicular light-guiding body 20. The light diffusion part diffuses the light internally reflected by the second reflection surfaces 23, and the light internally reflected by the upper reflection surface 34. Therefore, the light emitted from the upper surface 20h to the outside of the vehicular light-guiding body 20 can be inhibited from becoming glare.

[Operation]

Now, operation of the vehicular lamp 100 configured as described above will be described. FIG. 6 is a diagram illustrating an example of the diffusion pattern projected on a virtual screen in front of a vehicle. FIG. 6 illustrates the pattern for a vehicle which drives on the left side of the road. In FIG. 6, the V-V line indicates a vertical line of the screen, and the H-H line indicates a horizontal line on the left and right of the screen. Herein, an intersection of the vertical line and the horizontal line is assumed to be a reference position in the horizontal direction.

Each of the light sources 10 in the vehicular lamp 100 is turned on, so that light emitted from each of the light emitting surfaces 11 is emitted. This light is incident on the vehicular light-guiding body 20 from the first surface 21a and the second surface 21b of each incidence surface 21. The light incident from each first surface 21a travels toward the first reflection surface 22. The light incident from each second surface 21b is internally reflected toward the second reflection surface 23 in the first reflection surface 22.

As illustrated in FIG. 5, light L1, light L2, light L3, light L4 and light L5 which are each a portion of light reflected by the condensing pattern forming surface 23M in the second reflection surfaces 23 is guided by the vehicular light-guiding body 20, for example, as described below.

For example, the light L1 enters the protruding part 29, is transmitted through the transmission surfaces 30 disposed on the front side of the protruding part 29, and emits to the guiding body outer part. This light L1 travels to the guiding body outer part located on the front side, passes below the light blocking part 24, and is re-incident on an inner part of the vehicular light-guiding body 20 from the re-incidence surface 26. The re-incident light L1 reaches the emission surface 27, and emits from the emission surface 27 toward the front of the vehicle.

The light L2 enters the protruding part 29, is transmitted through the transmission surfaces 30 disposed on the front side of the protruding part 29, and emitted to the guiding body outer part. This light L1 travels to the guiding body outer part located on the front side, but is blocked or reflected by the second external light blocking part 36. This light L2 absorbs by the inner housing or the like disposed outside the vehicular light-guiding body 20.

The light L3 crosses over the protruding part 29 and reaches the inclined surface 33 of the recessed part 32. The light L3 is internally reflected toward the front of the vehicle by the inclined surface 33, passes above the light blocking part 24, and reaches the emission surface 27. The light L3 that reaches the emission surface 27 is emitted from the emission surface 27 to the front of the vehicle.

The light L4 crosses over the protruding part 29, and reaches the upper reflection surface 34 of the recessed part 32. The light L4 is internally reflected toward the front of the vehicle by the upper reflection surface 34. The light L4 is emitted to the guiding body outer part, for example, in a state of being reflected by the upper surface 20h of the vehicular light-guiding body 20, and being diffused by the prism part provided in the upper surface 20h. This light L4 is absorbed by the inner housing or the like disposed outside the vehicular light-guiding body 20.

The light L5 crosses over the protruding part 29 and the recessed part 32, and reaches the light blocking part 24. The light L5 is partially blocked by the light blocking part 24, and partially passes the light blocking part 24. The light L5 that passes the light blocking part 24 reaches the emission surface 27. The light L5 that reaches the emission surface 27 is emitted from the emission surface 27 to the front of the vehicle.

The light L1, the light L3, and the light L5 emitted from the emission surface 27 are projected as the diffusion pattern PF toward the front of the vehicle, as illustrated in FIG. 6. Specifically, the light L1, the light L3, and the light L5 that pass above the light blocking part 24, and reach the emission surface 27 form a condensing pattern Pla including the cutoff line CL in the low-beam pattern P1. In FIG. 6, a state in which the oblique cutoff line CLa in the cutoff line CL is formed so as to be inclined downward toward the right side is described as an example, but the present invention is not limited to this. Similar description can be made also for a case where the oblique cutoff line is inclined downward toward the left side.

The light L3 internally reflected by the inclined surface 33 passes a position closer to the light blocking part 24 compared to light internally reflected by a connecting surface 25 that is not provided with the inclined surface 33. Accordingly, in a case where the light emits from the emission surface 27, the light is projected to a region closer to the cutoff line CL. Therefore, compared to the case where no inclined surface 33 is provided, visibility from a long distance is improved.

Although diffusion light reflected by each diffusion pattern forming surfaces 23N in the second reflection surfaces 23 is not illustrated, the diffusion light partially crosses over the connecting surface 25, and is partially reflected by the connecting surface 25, passes above light blocking part 24, and reaches the emission surface 27. The diffusion light emitted from the emission surface 27 forms a diffusion pattern P1b in the low-beam pattern P1.

The light L1 that is emitted to the guiding body outer part by the transmission surfaces 30, passes below the light blocking part 24, and reaches the emission surface 27 forms the overhead pattern P2. It is possible to improve the utilization efficiency of light by using, as the overhead pattern P2, a portion of the light reflected by the second reflection surfaces 23.

The light L2 emitted to the guiding body outer part by the transmission surfaces 30 is re-incident from the re-incidence surface 26 to a guiding body inner part in a case where the second external light blocking part 36 is not provided (virtual light L2a). In a case where the virtual light L2a is emitted from the emission surface 27 to the vehicle front side, virtual light L2a is projected to the region PB in the vicinity of the H-H line in the overhead pattern P2. In this embodiment, the second external light blocking part 36 is provided, and therefore light projected to the region PB is reduced. Therefore, it is possible to suppress generation of glare light in the vicinity of the H-H line.

[Vehicular Lamp Unit]

FIG. 7 is a diagram illustrating an example of a vehicular lamp unit 200 according to this embodiment. FIG. 7 illustrates an example viewed from the front side in the onboard state. The vehicular lamp unit 200 illustrated in FIG. 7 has a housing 201, an outer lens 202, light sources 10, and a plurality of vehicular light-guiding bodies 20. Herein, the vehicular lamp unit 200 has a configuration in which the two vehicular light-guiding bodies 20 are disposed in a lamp chamber surrounded by the housing 201 and the outer lens 202, for example. The number of the vehicular light-guiding bodies 20 to be disposed in the lamp chamber may be one or three or more. The arrangement of the vehicular light-guiding bodies 20 is not limited to the arrangement in which the vehicular light-guiding bodies 20 are disposed side by side in the left-right direction as viewed from the front. The vehicular light-guiding bodies 20 may be disposed side by side in the up-down direction, may be disposed side by side in the oblique direction, or may be disposed side by side in a state in which at least two of the left-right direction, the up-down direction, and the oblique direction are combined. For different vehicular light-guiding bodies 20, the number and the arrangement of the light sources 10 may be different.

For example, one of the vehicular light-guiding bodies 20 may have a configuration for condensing in which the light sources 10 are disposed such that light is incident on the central incidence surfaces 21M, and the other vehicular light-guiding body 20 may have a configuration for diffusion in which the light sources 10 are disposed such that light is incident on the outer incidence surfaces 21N. A plurality of the vehicular light-guiding bodies each having at least one of the configuration for condensing and the configuration for diffusion may be provided. In this case, while heat generated from each vehicular light-guiding body 20 is suppressed, a condensing pattern P1a and a diffusion pattern P1b can be formed in front of a vehicle, as the whole vehicular lamp unit 200.

As described above, the vehicular light-guiding body 20 according to this embodiment includes: the incidence surfaces 21 on which light from the light sources 10 are incident; the first reflection surfaces 22 that internally reflect the light incident from the incidence surfaces 21 and convert the light into substantially parallel light; the second reflection surfaces 23 that internally reflect, forward in the front-rear direction in the onboard state, the substantially parallel light from the first reflection surfaces 22; the light blocking part 24 that blocks a portion of the light reflected by the second reflection surfaces 23; the connecting surface 25 that connects the second reflection surfaces 23 and the light blocking part 24, and has the transmission surfaces 30 which transmit a portion of the light reflected by the second reflection surfaces 23 from the lower side in the up-down direction on the onboard state to the guiding body outer part, and directs the light forward in the front-rear direction; and the re-incidence surface 26 that is disposed on the front side in the front-rear direction with respect to the transmission surfaces 30 and on the lower side in the up-down direction with respect to the light blocking part 24, and allows the light transmitted from the transmission surfaces 30 to the guiding body outer part to be re-incident; and, the emission surface 27 that emits the light internally reflected by the second reflection surface 23, and the light incident from the re-incidence surface 26.

According to this configuration, a main pattern (low-beam pattern P1) is formed by light that is reflected by the second reflection surfaces 23, that passes through the light blocking part 24 or above the light blocking part 24, and that is emitted from the emission surface 27. In addition, another pattern (overhead pattern P2) is formed on the upper side in front of the vehicle by light that is emitted to the guiding body outer part by the transmission surfaces 30, that passes below the light blocking part 24, that is re-incident from the re-incidence surface 26, and that is emitted from the emission surface 27. Thus, a portion of light incident from the incidence surfaces 21 is used as light forming the pattern (overhead pattern P2) different from the main pattern (low-beam pattern P1), so that it is possible to improve the utilization efficiency of light.

In the above vehicular light-guiding body 20, the second reflection surfaces 23 have the condensing pattern forming surface 23M that internally reflects the substantially parallel light such that the substantially parallel light is condensed forward in the front-rear direction, and the transmission surfaces 30 are disposed within the region AR where reflected light internally reflected by the condensing pattern forming surface 23M passes, as viewed from the up-down direction. Consequently, a portion of the light forming the condensing pattern Pla in the low-beam pattern P1 is used, so that it is possible to form the overhead pattern P2 condensed in front of the vehicle.

In the above vehicular light-guiding body 20, the connecting surface 25 has the recessed part 32 located on the front side with respect to the transmission surfaces 30, and recessed toward the guiding body inner part, and the inclined surface that is a portion of the recessed part 32, that is provided between the transmission surfaces 30 and the light blocking part 24 in the connecting surface 25 so as to be inclined downward in the up-down direction toward the front side in the front-rear direction, and that internally reflects, forward in the front-rear direction, a portion of the light reflected by the second reflection surface 23 is further provided. The light internally reflected on the inclined surface 33 passes through a position closer to the light blocking part 24, compared to light internally reflected on the connecting surface 25 that is not provided with the inclined surface 33. Accordingly, in a case where the light emits from the emission surface 27, the light is projected to a region closer to the cutoff line CL. Therefore, compared to the case where no inclined surface 33 is provided, visibility from a long distance is improved. In this configuration, the inclined surface 33 disposed in front of the transmission surfaces 30 is provided as a portion of the recessed part 32, so that it is possible to prevent blocking of light transmitted through the transmission surfaces 30 and traveling toward the guiding body outer part located on the front side, for example, compared to the case where the inclined surface 33 is provided as a portion of the protruding part that protrudes toward the lower side of the connecting surface 25.

In the above vehicular light-guiding body 20, the inclined surface 33 has the first external light blocking part 35 that is disposed so as to protrude on the guiding body outer part, and blocks a portion of light transmitted from the transmission surfaces 30 to the guiding body outer part. In the above vehicular light-guiding body 20, the second external light blocking part 36 that is disposed on the front side in the front-rear direction with respect to the transmission surfaces 30 in the connecting surface 25 so as to protrude on the guiding body outer part, and blocks a portion of light transmitted from the transmission surfaces 30 to the guiding body outer part is further provided. In this configuration, light projected to a portion of the region of the pattern (overhead pattern P2) formed on the upper part in front of the vehicle is reduced. Consequently, it is possible to suppress, for example, illusion on the side of a vehicle ahead or on the side of an oncoming vehicle, or suppress the generation of glare light.

In the above vehicular light-guiding body 20, the transmission surfaces 30 are disposed on both sides with a space at a central part in the left-right direction in the onboard state. Consequently, light that passes the central part in the left-right direction in the onboard state in the region AR can be used as light that forms the low-beam pattern P1 acting as a main pattern, and light that passes both sides in the left-right direction can be effectively used as another overhead pattern P2. The transmission surfaces 30 are disposed with the space on the left and right, so that it is possible to sufficiently obtain left and right diffusion of the overhead pattern P2, and it is possible to suppress excessive rise of the luminous intensity of the central p art.

In the above vehicular light-guiding body 20, the emission surface 27 projects the diffusion pattern PF toward the front of the vehicle. In this configuration, the diffusion pattern PF can be formed in front of the vehicle while effectively using light by the vehicular light-guiding body 20 integrated from the incidence surfaces 21 to the emission surface 27.

The vehicular lamp unit 200 according to this embodiment includes the light sources 10, and a plurality of the vehicular light-guiding bodies 20 that guide and emit light from the light sources 10. According to this configuration, the vehicular lamp unit 200 as a whole can obtain the diffusion pattern PF that combines the projection patterns of a plurality of the vehicular light-guiding bodies 20.

The technical scope of the present invention is not limited to the above embodiments, and changes may be made as appropriate without departing from the gist of the present invention. In the above embodiments, the configuration of the vehicular lamp 100 to be mounted on a vehicle that travels on a road with left-hand traffic is described as an example, but the present invention is not limited to this, and the same description is possible when the vehicular headlight can be mounted on a vehicle which travels on a road with right-hand traffic.

In the above embodiments, the low-beam pattern is described as an example of the diffusion pattern PF, but the present invention is not limited to this, and may be any other pattern, such as a high beam pattern, for example. In the vehicular lamp unit 200 provided with a plurality of the vehicular light-guiding bodies 20 therein, vehicular light-guiding bodies 20 that form different types of patterns may be provided.

### DESCRIPTION OF REFERENCE NUMERALS

AR, PA, PB . . . region

CL . . . cutoff line

CLa . . . oblique cutoff line

LMa, LMb, LNa, LNb, LNc, LNd . . . virtual straight line

L1 to L5 . . . light

L2a . . . virtual light

P . . . focal point

PF . . . diffusion pattern

P1 . . . low-beam pattern

P1a . . . condensing pattern

P1b . . . diffusion pattern

P2 . . . overhead pattern

10 . . . light source

11 . . . light emitting surface

20 . . . vehicular light-guiding body

20g . . . corner

20h . . . upper surface

21 . . . incidence surface

21M . . . central incidence surface

21N . . . outer incidence surface

21a . . . first surface

21b . . . second surface

21c . . . incident side reflection surface

22 . . . first reflection surface

23 . . . second reflection surface

23M . . . condensing pattern forming surface

23N . . . diffusion pattern forming surface

24 . . . light blocking part

25 . . . connecting surface

26 . . . re-incidence surface

27 . . . emission surface

29 . . . protruding part

29a . . . cutout surface

30 . . . transmission surface

31 . . . transmission-side reflection surface

32 . . . recessed part

33 . . . inclined surface

34 . . . upper reflection surface

35 . . . first external light blocking part

36 . . . second external light blocking part

100 . . . vehicular lamp

200 . . . vehicular lamp unit

201 . . . housing

202 . . . outer lens

1. A vehicular light-guiding body comprising:
an incidence surface on which light from a light source is incident;
a first reflection surface that internally reflects the light incident from the incidence surface and converts the light into substantially parallel light;
a second reflection surface that internally reflects, forward in a front-rear direction in an onboard state, the substantially parallel light from the first reflection surface;
a light blocking part that blocks a portion of the light reflected by the second reflection surface;
a connecting surface that connects the second reflection surface and the light blocking part, and has a transmission surface which transmits a portion of the light reflected by the second reflection surface from a lower side in an up-down direction on the onboard state to a guiding body outer part, and directs the light forward in the front-rear direction;
a re-incidence surface that is disposed on a front side in the front-rear direction with respect to the transmission surface and on a lower side in the up-down direction with respect to the light blocking part, and allows the light transmitted from the transmission surface to the guiding body outer part to be re-incident; and
an emission surface that emits the light internally reflected by the second reflection surface, and the light incident from the re-incidence surface.

2. The vehicular light-guiding body according to claim 1, wherein
the second reflection surface has a condensing pattern forming surface (23M) that internally reflects the substantially parallel light such that the substantially parallel light is condensed forward in the front-rear direction, and
the transmission surface is disposed within a region where reflected light internally reflected by the condensing pattern forming surface (23M) passes, as viewed from the up-down direction.

3. The vehicular light-guiding body according to claim 1, wherein
the connecting surface has a recessed part disposed on the front side in the front-rear direction with respect to the transmission surface, and recessed toward a guiding body inner part, and the vehicular light-guiding body further comprises:
an inclined surface that is a portion of the recessed part, that is provided between the transmission surface and the light blocking part in the connecting surface so as to be inclined downward in the up-down direction toward the front side in the front-rear direction, and that internally reflects, forward in the front-rear direction, a portion of the light reflected by the second reflection surface.

4. The vehicular light-guiding body according to claim 3, wherein
the inclined surface has a first external light blocking part that is disposed so as to protrude on the guiding body outer part, and blocks a portion of light transmitted from the transmission surface to the guiding body outer part.

5. The vehicular light-guiding body according to claim 3, further comprising:
a second external light blocking part that is disposed on the front side in the front-rear direction with respect to the transmission surface in the connecting surface so as to protrude on the guiding body outer part, and blocks a portion of light transmitted from the transmission surface to the guiding body outer part.

6. The vehicular light-guiding body according to claim 1, wherein
the transmission surface includes transmission surfaces which are disposed on both sides with a space at a central part in a left-right direction in the onboard state.

7. The vehicular light-guiding body according to claim 1, wherein
the emission surface projects a diffusion pattern toward a front of a vehicle.

8. A vehicular lamp unit comprising:
a light source; and
a plurality of the vehicular light-guiding bodies according to claim 1, each of the vehicular light-guiding bodies being configured to guide and emit light from the light source.
